(19) United States
(12) Patent Application Publication
(10) Pub. No.: US 2004/0069217 A1
(43) Pub. Date: Apr. 15, 2004

(54) Inner wiping apparatus and method for flexible open-ended substrate

(75) Inventors: Jeffrey R. Murray, Palmyra, NY (US); Michel F. Molaire, Rochester, NY (US); Colin M. Davey, Sodus Point, NY (US)

Correspondence Address: Lawrence P. Kessler, NexPress Solutions LLC, Patent Department, 1447 St. Paul Street, Rochester, NY, 14653-7103, US

(73) Assignee: NexPress Solutions LLC

(21) Appl. No.: 10/617,009

(22) Filed: Jul. 10, 2003

Related U.S. Application Data
(60) Provisional application No. 60/417,947, filed on Oct. 11, 2002.

(51) Int. Cl. B05C 11/02

(52) U.S. Cl. 118/105; 118/100; 427/235

(57) ABSTRACT

A cleaning brush and method for removing a coating solution from the inner end of a flexible, tubular substrate to be fitted over a mandrel or drum. After a tubular substrate is dipped endwise in a coating solution, some solution coats the inner face of the substrate at one end. By using moderate deformation of the substrate, changes to the profile of the cleaning brush, or both, the cleaning brush is fitted inside the end of the tubular substrate without damaging the substrate. The cleaning brush engages and cleans the substrate's inner surface. The substrate is then free from any coating so as to readily fit on the mandrel or drum.

### FIELD OF THE INVENTION

This invention relates in general to the process of fabrication of electrophotographic printing components, and in particular to the cleaning of substrates used in the transfer of imaging information in electrophotographic printing.

### BACKGROUND OF THE INVENTION

Electrophotographic copiers and printers carry out the basic electrophotographic imaging process of uniformly charging a photoconductive layer of a recording element with electrostatic charge, image-wise exposing the charged layer to radiation adapted to discharge the layer, thereby leaving behind a latent charge image, and applying pigmented electroscopic particles (toner) to the charge image to render it visible. Most often, the toner image so formed is transferred to a receiver whereupon the toner image is made permanent by heat and/or pressure. Optionally, for example, to extend the life of the photoconductive recording element, the toner image formed on the recording element is transferred to an intermediate transfer drum or the like before it is again transferred to the receiver.

Typical well-known electrophotographic printing processes use specialized coatings on rotating drums to facilitate the transfer of visible imaging information (toner) from a charged source to a receiving medium, e.g., paper. The application of such a coating to a drum (or mandrel) surface is typically done by applying the coating to a separate thin substrate, and then bonding or mounting the substrate on the drum surface. Such drums are heavy, bulky, and hard to handle during manufacture without risking loss of the requisite tolerances of diameter and smoothness of the surface drum. The separation of the coating process and the mounting process eliminates any need for special handling of the drum during the coating process. The substrates used are typically produced in hollow, tubular form for fitting to a drum or mandrel.

In order to obtain desired electrophotographic properties for printing, the surfaces of such hollow, tubular substrates must be coated to tolerances on the order of microns. Equipment for dip coating a flexible substrate is known to those skilled in the art. Examples of such devices are illustrated in the following patents: U.S. Pat. No. 6,312,522, in the names of Dinh, et al.; U.S. Pat. No. 6,132,810, in the names of Swain, et al.; U.S. Pat. No. 5,683,755, in the names of Godlove, et al.; U.S. Pat. No. 5,520,399, in the names of Swain, et al.; and U.S. Pat. No. 4,448,798, in the names of Kageyama, et al., whose disclosures are incorporated by reference. Due to the closeness of fit between such substrates and the respective drums (cylindrical supports) on which the substrates are mounted, the presence of a coating solution on the inner surface of the substrates is unacceptable.

A typical wiping process for removing coating solution from the inside bottom surface of the thin substrate utilizes a spinning, solvent-laden sponge or brush that contacts the inner surface of the substrate. The brush/substrate contact area, the brush rotational speed, the wiping dwell time, and the number of wiping repetitions are critical parameters for cleaning the contamination from the substrate.

Typical wiping brushes available from commercial coating equipment suppliers are round, somewhat rigid, porous disks made from materials such as polyethylene. To make the wiping process effective, the solvent-laden wiping brush and the inside surface of the substrate must have contact. To allow such contact, the inner diameter of the substrate and the outer diameter of the effective portion of the wiping brush must be nearly the same, (see prior art FIGS. 2A, 2B, 2C). Typically the circular wiping brush 100 has a tapered surface 101, resembling a truncated cone, at the end where the substrate first makes contact on entry within the substrate. The tapered surface 101 ensures proper engagement and alignment between the substrate and the circular wiping brush 100.

The actual wiping occurs not at the tapered surface 101 but at a lower portion 102 of the circular wiping brush 100 that has been sized and shaped similarly to the counter bore of the substrate. A substrate may have a straight counter bore or a tapered counter bore. A substrate with a straight counter bore presents two problems for the wiping process. First, the brush often expands or swells as dwell time in the wiping solvent and coating fluid from the substrate increases. Second, there is some variability in the inner diameter of the substrates. These two factors can make reliable wiping of any substrate with a straight counter bore (rigid or flexible) a challenge since it is nearly impossible to keep the inside diameter of the substrate and the outside diameter of the effective portion of the brush the same. A flexible substrate is harder to clean because it is difficult to guarantee that the bottom opening of the flexible substrate is consistently round. Lack of roundness in the flexible substrate makes its engagement and contact with the round cleaning brush a difficult task.

By contrast, a rigid, thick-walled substrate can be more reliably mounted on a round disk shaped brush of nearly equal size. When the rigid substrate does not have a straight counter bore, but instead has a tapered counter bore, the problem of ensuring brush/substrate contact is eliminated. Reliable wiping of a flexible open-ended substrate with a straight counter bore is not adequately addressed in conventional processes.

### SUMMARY OF THE INVENTION

The invention provides a cleaning brush and a method of its use to remove coating solution from the inner end of a flexible tubular substrate to be fitted over a mandrel or drum in an electrophotographic printer. After the tubular substrate is dipped endwise in a coating solution, some solution coats part of the inner face of the substrate at one end. The substrate is deformed by the cleaning brush, changing it to the profile of the cleaning brush, or changes the circumference of the brush to conform to the inner surface of the substrate, or both. The invention fits its cleaning brush inside the end of the tubular substrate without damaging the substrate, cleans the substrate's inner surface, and frees the substrate for fitting on the mandrel or drum.

### BRIEF DESCRIPTION OF THE DRAWINGS

FIGS. 1A through 1E show successive stages in the dipping and cleaning process for a substrate;

FIGS. 2A, 2B, and 2C show respectively, end, perspective and elevational views of a cleaning brush according to the prior art;

FIGS. 3A, 3B, and 3C show respectively, end, perspective and elevational views of a first embodiment of the cleaning brush according to this invention;

FIG. 3D shows the end of a substrate as fitted over the cleaning brush;

FIGS. 4A through 4D show the method of cleaning using the first embodiment according to this invention;

FIGS. 5A and 5B show respectively, end and perspective views of a second embodiment of the invention having a cleaning brush with extensions;

FIGS. 5C and 5D show end views of a second embodiment of the invention and the substrate fitted over the brush, when the brush is respectively stationary and rotating;

FIGS. 6A, 6B, and 6C show respectively, end, perspective and elevational views of a third embodiment of the invention having a cleaning brush with attached bands of cleaning material;

FIGS. 7A and 7B show a fourth embodiment of the invention having a cleaning brush split into two retractable parts, with two slightly recessed segments on each part;

FIGS. 8A through 8D show the method of cleaning using the fourth embodiment according to this invention;

FIGS. 9A and 9B show a fifth embodiment of the invention having a cleaning brush split into four retractable parts;

FIGS. 10A through 10D show the method of cleaning using the fifth embodiment according to this invention;

FIGS. 11A through 11C show the method of fabricating the cleaning brush, as in the first embodiment according to this invention;

FIGS. 12A through 12D show the method of fabricating the cleaning brush, as in the fourth embodiment according to this invention; and

FIGS. 13A through 13D show the method of fabricating the cleaning brush, as in the fifth embodiment according to this invention.

### DETAILED DESCRIPTION OF THE INVENTION

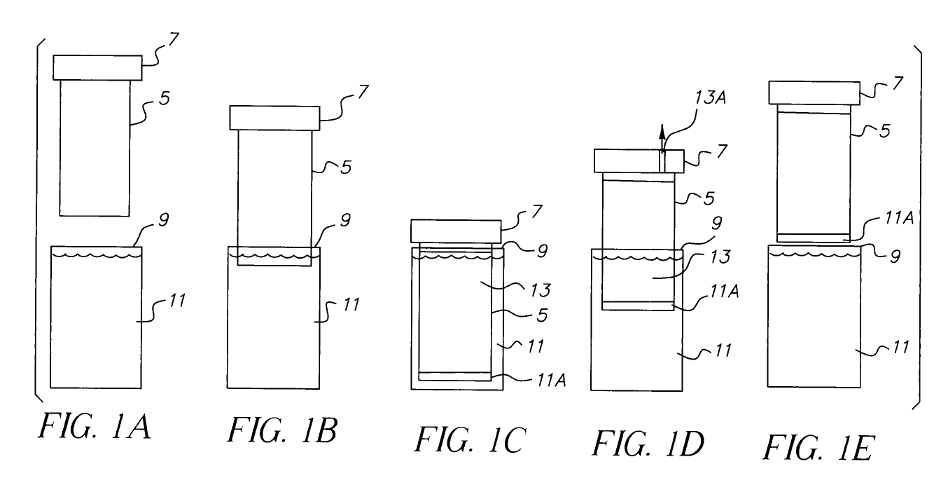

The invention comprises an apparatus and a method for reliably removing the coating solution from the inside surface of a flexible, open-ended, tubular substrate that is coated using a dip coating method. See FIGS. 1A through 1E. The coating process is as follows: the substrate 5 is mounted and held at one end by a chuck 7 (FIG. 1A). The substrate 5 is then dipped into a tank 9 containing the coating solution 11 (FIG. 1B). During dipping, the chuck 7 seals the upper end opening of the substrate 5 so that the pressure of vapor 13 within the substrate 5 prevents the coating solution 11 from rising inside the substrate 5, as shown in FIG. 1C.

The substrate 5 is sealed at one end by the chuck 7 and at the other end by the coating solution 11. While withdrawing the substrate 5 from the coating solution 11 it is necessary to vent solvent vapor pressure 13A, as in FIG. 1D, that can build inside of the substrate. If the venting does not occur and the solvent vapor pressure builds sufficiently, the vapor will bubble outside the substrate, through the coating solution, and degrade the coating quality. The vapor bubbles disrupt the coating fluid surface and meniscus, causing coating film defects.

While the venting process is necessary to prevent such problems, the venting process also allows some coating solution to contact the inside lower edge of the substrate. The result is that the inside lower margin of the substrate 5 receives coating 11A as shown in FIG. 1E, thereby making the substrate's inner diameter smaller. This reduction in the inner diameter of the substrate is unacceptable. Typically, the inner surface of the flexible substrate will be the contact surface with a high precision mandrel or other mounting device in the print engine. In order to maintain the high precision inner diameter required by the mandrel-plus-thin substrate system, the inner surface of the thin substrate must be free from any contamination. If the substrate's inner surface is contaminated and its inner diameter is too small, the substrate cannot be fitted over the mandrel.

Such inner surface contamination is prevented as follows. In a typical dip coating process, after the substrate 5 has exited the coating fluid, it is moved by the coating chuck to an inner wiping unit. The inner wiping unit removes any coating fluid that has coated onto the inside surface of the substrate during the coating venting process. The removal of the coating fluid from the inside surface facilitates fitting of the substrate over the mandrel. Even the smallest amount of coating fluid left on the substrate may create a layer sufficiently thick to prevent fitting the substrate and mandrel together as required.

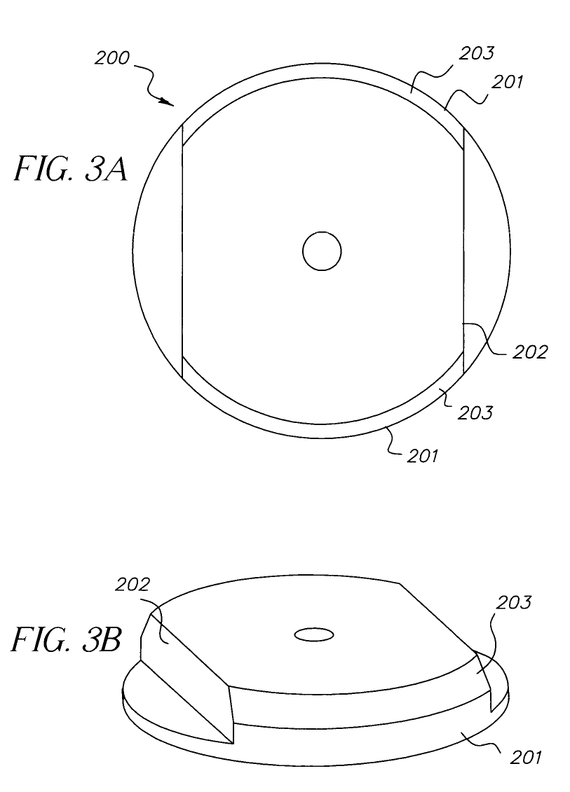

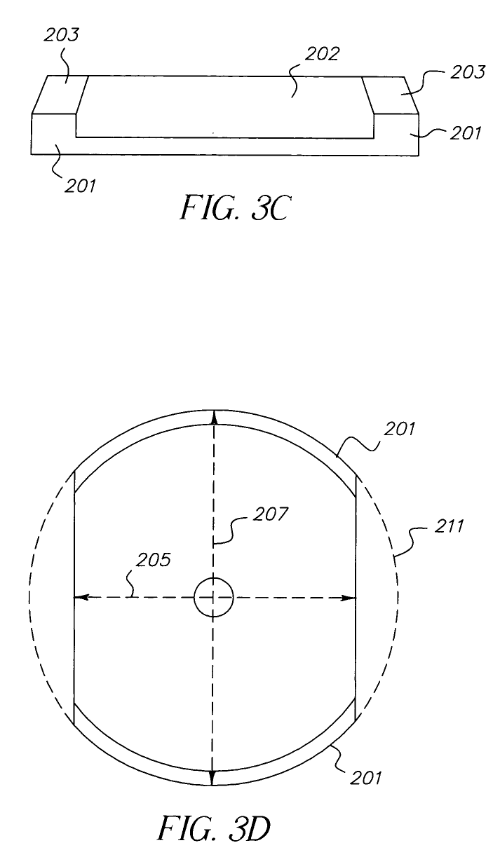

The invention facilitates the insertion and effective use of a wiping unit's cleaning brush within a flexible substrate as follows. The invention incorporates a cleaning brush of variable diameter, having an oblong cleaning brush 200 when viewed along its center axis as shown in FIG. 3A. The oblong profile includes one or more cleaning portions 201 having a diameter sufficiently large enough to let the cleaning brush engage with the inner surface of the substrate for cleaning of the substrate, one or more tapered portions 203 to engage initially the lower end of the substrate for fitting over the remainder of the cleaning brush, and one or more recessed segments 202 which allow the lower end of the substrate to be fitted over the cleaning brush while the cleaning brush is spinning. See FIGS. 3B, 3C, and 3D for additional views of the cleaning brush 200 according to this invention.

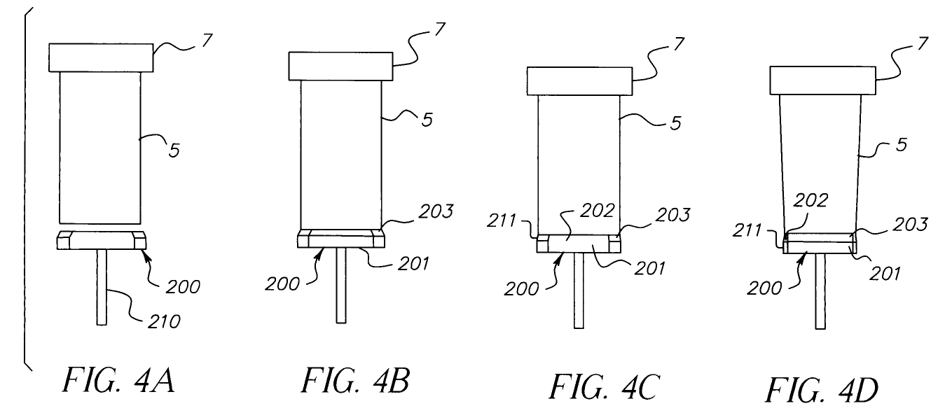

When the inner portion of a flexible substrate 5 with straight counter bore is to be wiped clean of coating solution, the lower end of the dipped substrate is positioned over the oblong cleaning brush 200 (FIG. 4A). The brush 200 is mounted on the end of a rod 210. The rod is operable to move the brush into and out of the open end of the substrate 5. The rod is also operable to rotate the brush 200. The oblong cleaning brush 200 is spun by the rod 210 while the lower end of the dipped substrate 5 is lowered onto the brush as shown in FIG. 4B. As the substrate's lower end engages with the tapered portions 203 of the spinning brush, the brush's tapered portions deform the substrate's lower end into an increasingly elongated shape by applying increasing outward pressure to two or more portions of the lower end's circumference. The elongation of the substrate's lower end draws the remaining portions of the lower end's circumference closer together and into the spaces left by the recessed segments 202 of the cleaning brush. The lower end of the substrate is lowered far enough to engage the elongated portions of the lower end fully with the cleaning portions 201 of the cleaning brush as the brush turns (FIG. 4C). The cleaning portions 201 apply pressure to clean the lower end of the substrate while the substrate is in an oblong shape 211 as shown in FIG. 3D and FIGS. 4C and 4D. The inherent elasticity of the substrate ensures that the substrate will engage closely with the cleaning portion 201 of the cleaning brush 200 and then return to its nominal cylindrical shape.

The smaller diameter 205 of the oblong brush, (shown in FIG. 3D) is less than the nominal inner diameter of the substrate 5, and the longer diameter 207 (shown in FIG. 3D) of the oblong brush is slightly greater than the nominal inner diameter of the substrate. When the brush 200 spins, the long diameter portion of the brush makes contact along the inner circumference of the substrate as in FIG. 4C, thereby cleaning the inside reliably and consistently. By increasing the length of the arc of the longer diameter 207 on the oblong shaped brush, the wiping efficiency can be optimized. The length of the arc of the brush's longer diameter can be made as close to fully circular as will permit the deformed substrate to be fitted over it.

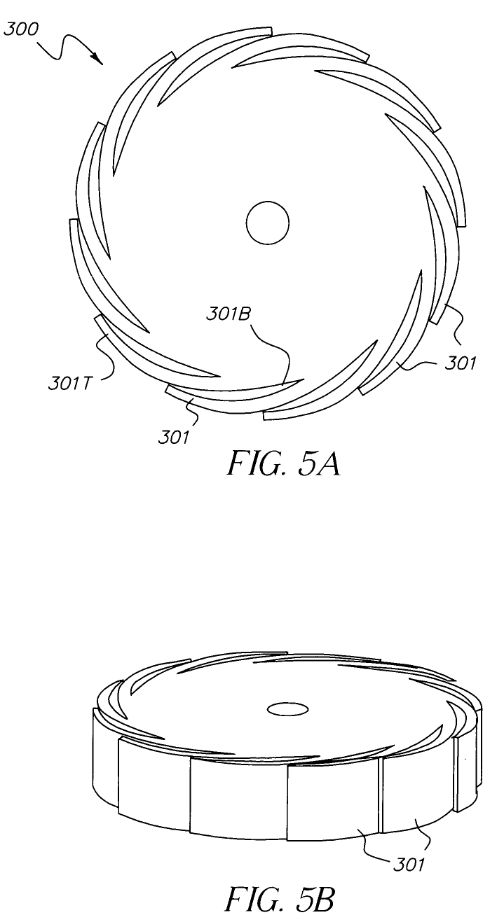

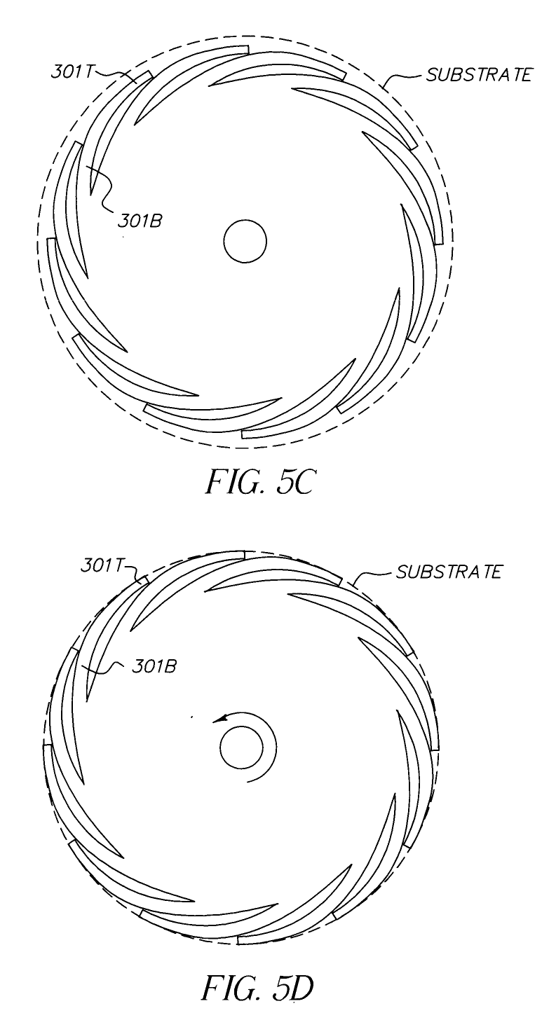

In a second embodiment, according to the invention, the cleaning brush 300 has semi-rigid, tentacle-like brush extensions 301, (see FIGS. 5A and 5B). The brush extensions 301 are flexible enough to maintain contact with the inner surface of a substrate 5, yet rigid enough, and of sufficient number (population) to wipe the surface effectively while the brush spins. The extensions 301 are constructed of a porous material, similar to that used in typical cleaning brushes, allowing them to absorb cleaning fluid and remove coating solution. Note that although FIGS. 5A and 5B show the extensions 301 as an integral part of the body of the brush 300, in further variations of the second embodiment the brush extensions may be fabricated as extensions of an annular ring to be fitted around the solid, smaller core of the brush, or as individual extensions attached one by one to the circumference of the solid, smaller core of the brush. In all variations of the second embodiment, the brush extensions are flexible enough to maintain contact with the inner surface of a substrate during cleaning, rigid enough and of sufficient number (population) and total cleaning surface to wipe the substrate's inner surface effectively, and sufficiently elastic to return to an overall diameter less than that of the interior of the substrate. The cleaning brush, in this embodiment, is fabricated with an outer diameter slightly smaller than the inner diameter of the substrate to be cleaned.

When the inner portion of a flexible substrate with straight counter bore is to be wiped clean of coating solution in the second embodiment of the invention, the lower end of the dipped substrate is positioned over the cleaning brush 301, and then lowered until its lower end encloses the cleaning surface of the brush, (see FIG. 5C). The cleaning brush 301 is then spun and the centripetal force of the body of the brush enables the tip areas 301T of the extensions 301 to swing outward and engage the inner surface of the stationary lower end of the substrate 5 for cleaning (FIG. 5D).

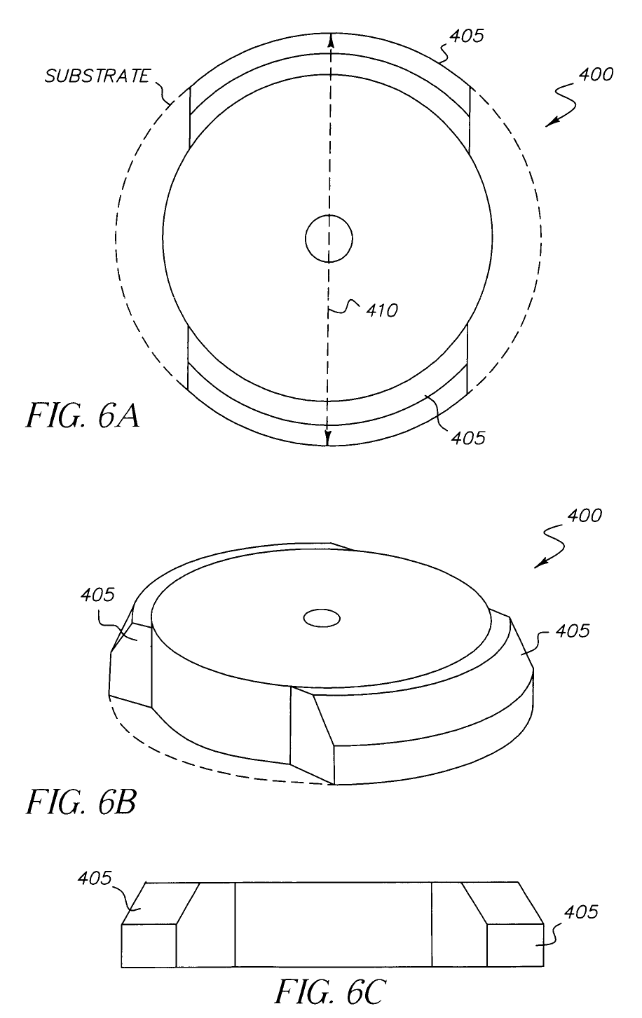

In a third embodiment, according to the invention, the cleaning brush 400 is round, with a smaller diameter than the inside diameter of the substrate to be cleaned (see FIGS. 6A through 6C). In this embodiment, the round brush 400 is made oblong as in the first embodiment by attaching bands of absorbent material 405 (such as polyethylene strips, cloth, or clean room wiping paper) at opposite sides of the brush, 180 degrees from each other. The material 405 applied must be thick enough to make the brush along diameter 410 larger than the inside diameter of the substrate. The bands of absorbent material 405 are glued or mechanically attached to the round brush 400. Cleaning the substrate in the third embodiment is performed as in the first embodiment.

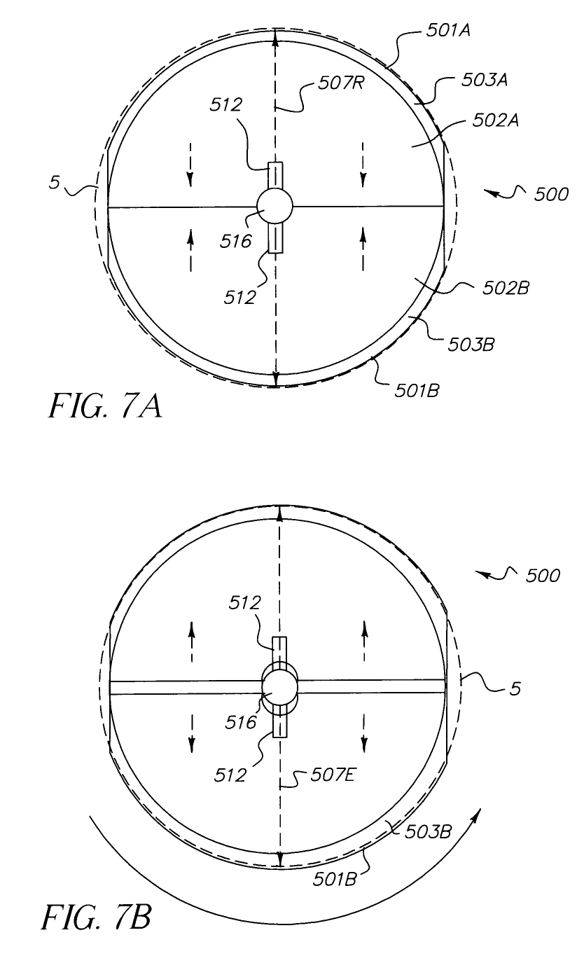

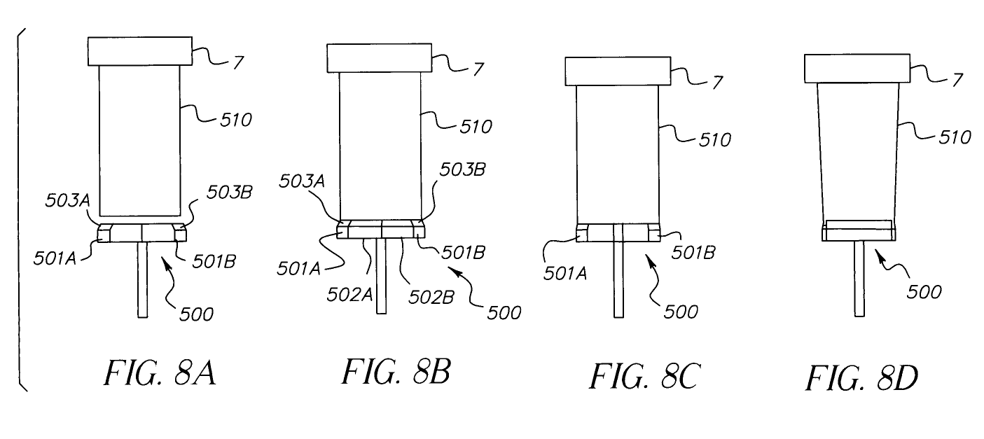

For a fourth embodiment of the invention, see FIGS. 7A and 7B, and FIGS. 8A through 8D. In the fourth embodiment, according to the invention the cleaning brush 500 is split into two parts 502A, 502B, each part with a tapered region 503A, 503B respectively as in the first embodiment. Each part 502A, 502B may be moved closer to the other part 502B, 502A as shown in FIG. 7A, to put the parts in a retracted position. This movement decreases the brush's longer diameter from a length 507E (FIG. 7B) to a length 507R, allowing a substrate 5 to be cleaned to be fitted over the brush. In a stationary state as in FIG. 8A, parts 502A and 502B are held in the retracted position by one or more tension devices such as springs or elastic bands.

Two cases of operation of the fourth embodiment of the invention may arise. In the first case, cleaning brush 500, with parts 502A and 502B in the retracted position, fits within the circumference of substrate 5 as shown in FIG. 8B. In this case, substrate 5 may be fully lowered over brush 500 until cleaning surfaces 501 A, 501B are in position for cleaning as shown in FIG. 8C.

In the second case, the cleaning brush 500 has swelled in the course of operation, and the diameter of its cleaning surfaces 501A, 501B may be slightly larger than the diameter of the substrate to be cleaned. As the substrate is lowered onto cleaning brush 500 (FIG. 8B), the lower end of substrate 5 engages with tapered portions 503A, 503B of the spinning brush, and the brush's tapered portions 503A, 503B deform the lower end of substrate 5 into an increasingly elongated shape by applying increasing outward pressure to two or more portions of the lower end's circumference, just as in the first embodiment. The elongation of the substrate's lower end draws the remaining portions of the lower end's circumference closer together as in the first embodiment. The lower end of the substrate is lowered far enough to engage the elongated portions of the lower end fully with the cleaning portions 501A, 501B of cleaning brush 500 as the brush turns.

Once the substrate is fitted over the cleaning brush and the brush is spinning, the spinning of the brush separates sectors 502A, 502B to engage the brush's cleaning portions 501A, 501B with the inner surface of the substrate 5 to be cleaned, as shown in FIG. 7B. The diameter of cleaning brush 500 expands to the length 507E as shown in FIG. 7B. Each sector 502A, 502B is connected to one end of a telescoping rod 512 and the other end of the rod is connected to central hub 516 in the center of the cleaning brush. Holding and repositioning the sector parts 502A, 502B in either the retracted position or the working position may be done using the telescoping rods 512 or other suitable sliding frames and a tension device attached to the shaft on which the brush is mounted and to each part 502A, 502B, or any similar conventional mechanism known in the art. In this fourth embodiment, the substrate to be cleaned may not need to be deformed as in the first embodiment to be fitted over the cleaning brush 500. Where deformation of substrate 5 is required due to swelling of cleaning brush 500, it appears as in FIG. 8D.

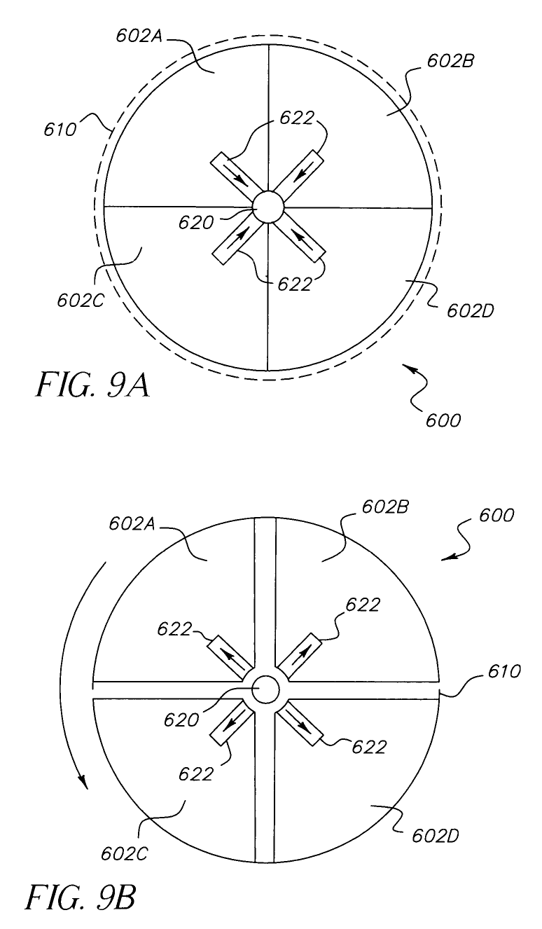

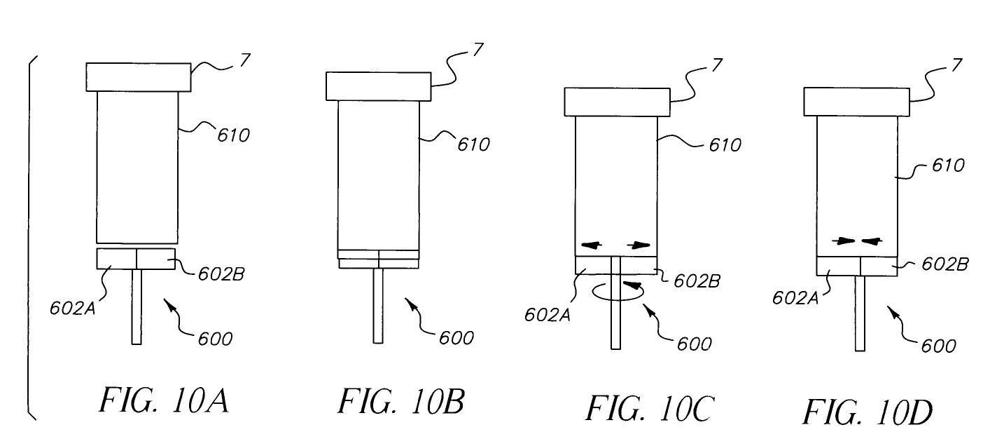

For a fifth embodiment according to this invention, see FIGS. 9A and 9B, and FIGS. 10A through 10D. In the fifth embodiment, the cleaning brush 600 is split into three or more parts or sectors. Each sector has a telescoping rod 622 attached at one end to the respective sector, and at the other end to a central hub 620. In FIGS. 9A and 9B, the cleaning brush 600 is split into four parts 602A, 602B, 602C, 602D, but any number of parts more than two will serve. Parts 602A, 602B, 602C, 602D may be retracted in a radial direction by moving them closer to each other as shown in FIG. 9A, thereby decreasing the cleaning brush's overall diameter and allowing a substrate 610 to be cleaned to be fitted over the brush. In a stationary state (see FIG. 10A), parts 602A, 602B, are held in the retracted position by one or more tension devices such as springs or elastic bands. Once the substrate is fitted over the cleaning brush (FIG. 10B), the parts 602A, 602B, 602C, 602D, may be moved apart from each other as in the fourth embodiment by spinning the cleaning brush to engage the brush's cleaning portions with the inner surface of the substrate 610 to be cleaned, as shown in FIG. 9B and FIG. 10C. Holding and repositioning the parts 602A, 602B, 602C, 602D may be done using a sliding frame and tension device attached to the central hub 620 on which the cleaning brush is mounted, and to each part 602A, 602B, 602C, 602D, or any similar conventional mechanism known in the art. When cleaning is completed, stopping the spinning of cleaning brush 600 retracts parts 602A, 602B, 602C, 602D from substrate 610. In this fifth embodiment, the substrate to be cleaned need not be deformed to be fitted over the cleaning brush.

The coating machine itself, in all embodiments, incorporates a gas tight chuck 7 for grasping, picking up, and transporting the cylindrical substrate 5 (610); one or more tanks or baths containing coating solutions in which the substrate is to be completely immersed; a venting mechanism in the chuck for venting gases from within the substrate during its immersion in the coating solution; a disk-shaped cleaning brush thick enough and absorbent enough to clean away any coating solution from the inner lower end of the substrate; an axial mounting for the cleaning brush; and a drive mechanism to engage the cleaning brush with the inner lower end of the substrate and to rotate the brush to clean the inner lower end of the substrate.

As described in detail above for different embodiments of the invention, the cleaning brush may be oblong, sectored, or both, and it may have extensions or attachments on its surface to perform the cleaning of the substrate.

In embodiments having an oblong cleaning brush, the coating machine also incorporates a mechanism for deforming the lower end of the cylindrical substrate to fit over the oblong cleaning brush. The deforming mechanism avoids contact with the freshly-coated outer surface of the substrate. In one embodiment, the deforming mechanism applies pressure at two opposite points on an inner circumference of the substrate, thereby elongating the substrate's outline at its lower, open-end. The upper end, held by the chuck 7 and sealed against the escape of vapor, does not deform.

In embodiments having a circular brush sectored into two or more parts, the coating machine also incorporates a mechanism for withdrawing the sectors inward in a radial direction to permit mounting and removal of the substrate relative to the cleaning brush, and for extending the sectors outward in a radial direction to engage the substrate's inner surface for cleaning.

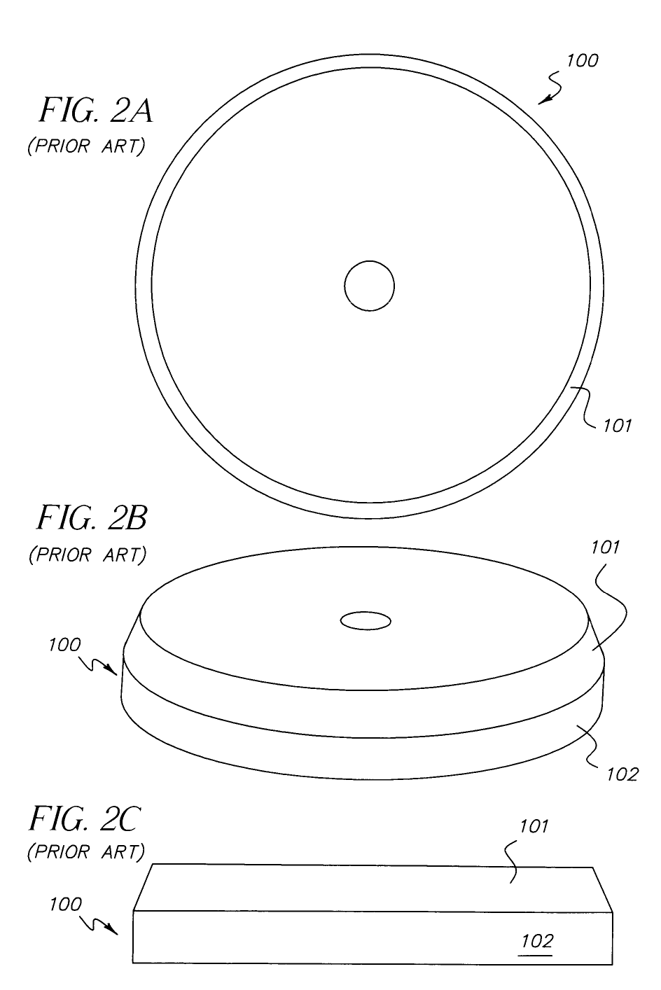

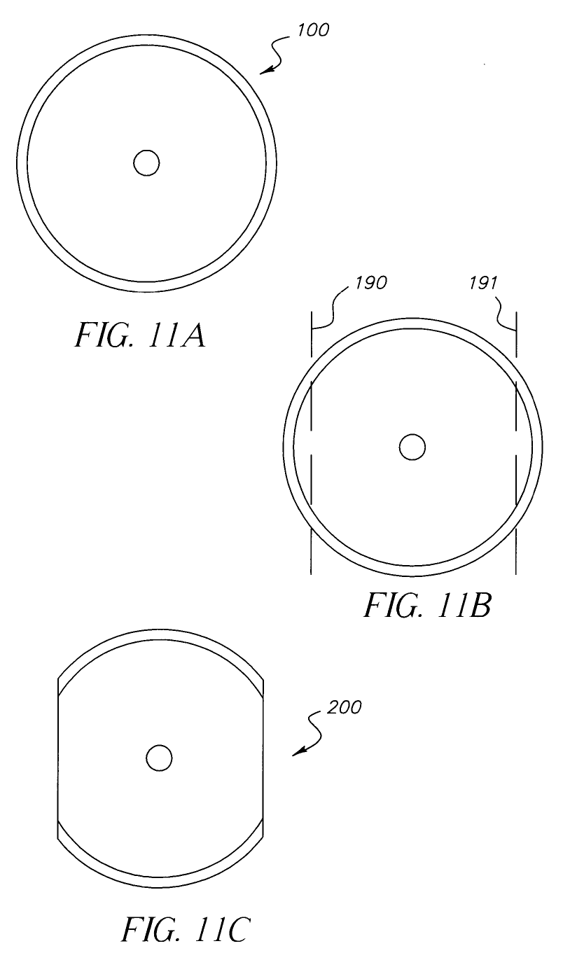

To fabricate a cleaning brush according to the first embodiment of the invention, a circular brush 100 as shown in FIG. 11A (and FIGS. 2A through 2C) is cut along lines 190 and 191 as in FIG. 11B to produce oblong cleaning brush 200, as shown in FIG. 11C.

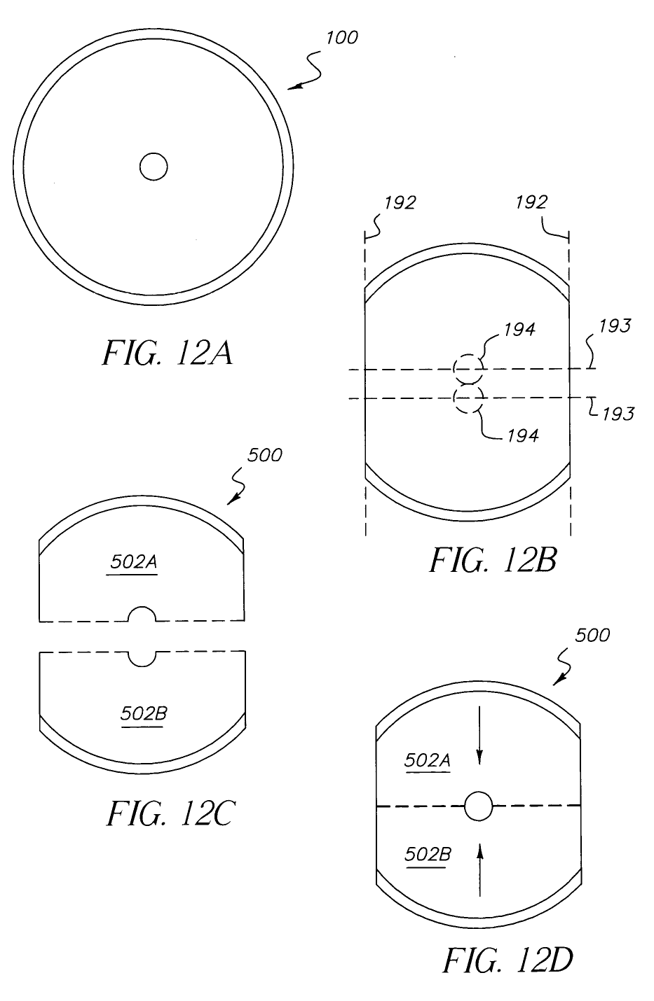

To fabricate a cleaning brush according to the fourth embodiment of the invention, a circular brush 100 as shown in FIG. 12A and FIGS. 2A through 2C is cut along lines 192, 193, 194 as in FIG. 12B to produce the two parts 502A and 502B of brush 500 as shown in FIG. 12C. In the retracted position, shown in FIG. 12D, parts 502A and 502B of cleaning brush 500 are drawn together to permnit fitting a substrate over the brush.

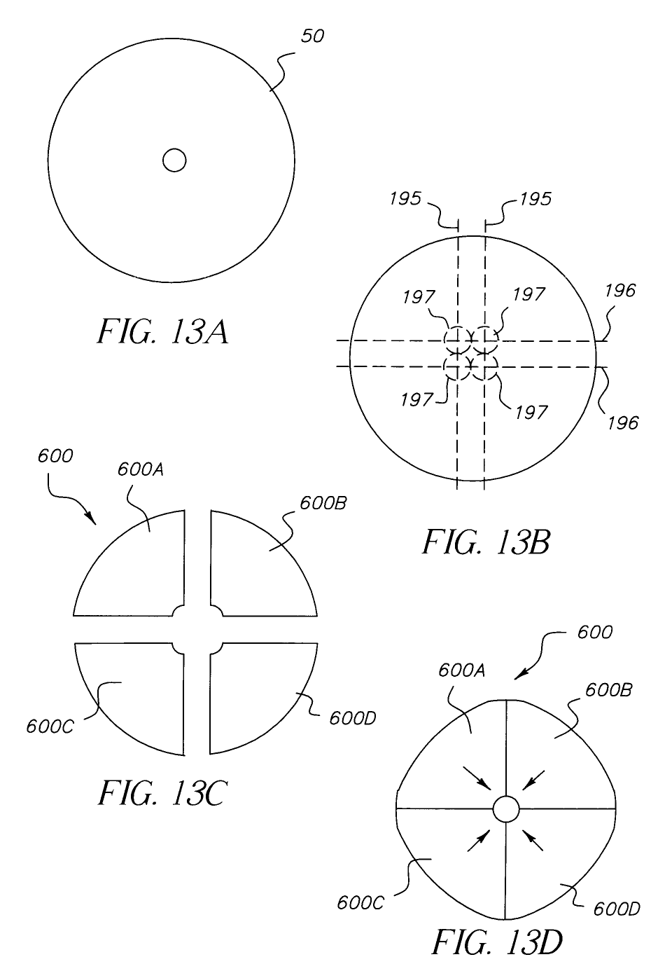

To fabricate a cleaning brush according to the fifth embodiment of the invention, a circular wiping brush 50 (FIG. 13A), not having the tapered portion as in brush 100 of FIG. 2A, is cut along lines 195, 196, 197 as in FIG. 13B to produce the four parts 600A through 600D of brush 600 as in FIG. 13C. In the retracted position, shown in FIG. 13D, parts 600A through 600D of cleaning brush 600 are drawn together to permit fitting a substrate over the brush.

The invention has been described in detail with particular reference to certain preferred embodiments thereof, but it will be understood that variations and modifications can be effected within the spirit and scope of the invention.

PARTS LIST

| | |
|---|---|
| 5 | substrate |
| 7 | chuck |
| 9 | tank |
| 11 | coating solution |
| 11A | coating |
| 13 | vapor |
| 13A | vapor pressure vent |
| 50 | circular brush |
| 100 | circular wiping brush |
| 101 | tapered surface |
| 102 | lower portion |
| 192 | line |
| 193 | line |
| 194 | line |
| 195 | line |
| 196 | line |
| 197 | line |
| 200 | oblong cleaning brush |
| 201 | cleaning portion |
| 202 | recessed segment |
| 203 | tapered portion |
| 205 | small diameter |
| 207 | longer diameter |
| 210 | rod |
| 211 | oblong shape |
| 300 | brush |
| 301 | brush extensions |
| 301B | bases |
| 301T | tip areas |
| 400 | round brush |
| 405 | bands of absorbent material |
| 410 | brush diameter |
| 500 | cleaning brush |
| 501A | cleaning portion |
| 501B | cleaning portion |
| 502A | part |
| 502B | part |
| 503A | tapered region |
| 503B | tapered region |
| 507E | diameter length extended |
| 507R | diameter length retracted |
| 510 | substrate |
| 512 | telescoping rod(s) |
| 516 | central hub |
| 600 | cleaning brush |
| 600A | part |
| 600B | part |
| 600C | part |
| 600D | part |
| 602A | part |
| 602B | part |
| 602C | part |
| 602D | part |
| 610 | substrate |
| 620 | central hub |
| 622 | telescoping rod(s) |

What is claimed is:

1. A wiping unit cleaning brush for cleaning coating solution from the inside, open, end of a flexible, tubular, dip-coated substrate, comprising:
a cleaning brush of variable diameter having an oblong profile when viewed along its axis of rotation; and
one or more cleaning portions and one or more recessed portions, said one or more cleaning portions having a diameter at least equal to or greater than the diameter of the diameter of a circle having the same circumference as the circumference of the flexible, tubular substrate so that the cleaning portions engage the inner surface of an end of the substrate to fit over the cleaning brush.

2. A wiping unit cleaning brush according to claim 1, wherein said cleaning brush of variable diameter have a central supporting disk and a plurality of flexible extensions that extend in a radial direction away from the outer edge of the central supporting disk, each flexible extension having one or more cleaning portions such that the effective diameter of the cleaning brush in the vicinity of a flexible extension is greater than the diameter of the diameter of a circle having the same circumference as the circumference of the flexible tubular substrate.

3. The wiping unit cleaning brush of claim 2, wherein the flexible extensions are distributed equally over the edge of the central disk.

4. The wiping unit cleaning brush of claim 3, wherein angularly adjacent flexible extensions overlap one another.

5. A wiping unit cleaning brush according to claim 1, wherein said cleaning brush of variable diameter has a central supporting disk and two or more arcuate segments attached to the central supporting disk for movement selectively toward or away from said central supporting disk, wherein the effective diameter of the cleaning brush is selectively greater than the diameter of the diameter of a circle having the same circumference as the circumference of the flexible tubular substrate.

6. The wiping unit cleaning brush of claim 5, wherein at least two arcuate segments are attached at diametrical opposite locations on the edge of the central supporting disk.

7. A wiping unit cleaning brush according to claim 1, wherein said cleaning brush of variable diameter is split into two or more cleaning sectors, telescoping rods connected at one end to a sector and at the other end to a central hub for extending in a radial direction one or more of the cleaning sectors from a retracted position to an extended position such that the effective diameter of the cleaning brush is selectively greater than the diameter of the diameter of a circle having the same circumference as the circumference of the flexible tubular substrate.

8. A method for cleaning coating solution from the inside, open, end of a flexible, tubular substrate, comprising the steps of:
holding the closed end of the flexible, tubular substrate stationary;
bringing a substantially disk-shaped cleaning brush of variable diameter, having an oblong profile when viewed axially, into axial alignment proximate to the open end of the flexible, tubular substrate;
engaging the open end of the flexible, tubular substrate with the cleaning brush to deform the end of the flexible, tubular substrate to fit over the cleaning brush;
spinning the cleaning brush so that the cleaning portions engage continuously with the inner surface of the end of the flexible, tubular substrate; and
withdrawing the cleaning brush from the inside, open end of the flexible, tubular substrate.

9. An apparatus for cleaning coating solution from an inside, open, end of a flexible, tubular substrate, comprising:
a cleaning brush of variable diameter having an oblong profile when viewed along its axis of rotation and having one or more tapered portions, one or more cleaning portions, and one or more recessed portions, said cleaning portions having a diameter sufficiently large enough so that the cleaning brush engages with the inner surface of the open end of the substrate for cleaning of said substrate, and said tapered portions and recessed portions allowing the open end of the substrate to be fitted over the cleaning brush;
a drive mechanism for inserting the cleaning brush into the inside, open, open end of the flexible, tubular substrate, and spinning the cleaning brush so that the cleaning portions engage continuously with the inner surface of the open end of the substrate; and
a chuck for holding the other end of the substrate.

10. An apparatus for cleaning coating solution from the inside, open, end of a flexible, tubular substrate, comprising:
a cleaning brush of variable diameter, including a central supporting disk and a plurality of extensions each supporting one or more cleaning portions, having a diameter sufficiently large to let the cleaning brush engage with the inner surface of the open end of the substrate for cleaning of said substrate, and one or more recessed portions allowing the open end of the substrate to be fitted over the cleaning brush;
a drive mechanism for inserting the cleaning brush into the inside, open, end of the flexible, tubular substrate, and spinning the cleaning brush so that the cleaning portions engage continuously with the inner surface of the open end of the substrate; and
a chuck for holding the other end of the substrate.

11. The apparatus of claim 10, wherein the cleaning portions comprise polyethylene.

12. The apparatus of claim 10, wherein the cleaning portions comprise cloth.

13. The apparatus of claim 10, wherein the cleaning portions comprise clean room wiping paper.
